(19) United States
(12) Patent Application Publication
(10) Pub. No.: US 2015/0113546 A1
(43) Pub. Date: Apr. 23, 2015

(54) SERVER AND METHOD FOR MANAGING APPLICATION SERVICES

(71) Applicant: POWER-ALL NETWORKS LIMITED, Shatin (HK)

(72) Inventors: MENG-MING HUANG, Shenzhen (CN); JUN LV, Shenzhen (CN); LIN-RONG CHEN, Shenzhen (CN)

(21) Appl. No.: 14/491,290

(22) Filed: Sep. 19, 2014

(30) Foreign Application Priority Data
Oct. 18, 2013 (CN) 2013104913300

(51) Int. Cl. G06F 9/54

(52) U.S. Cl. CPC G06F 9/547; G06F 2209/541
USPC 719/328

(57) ABSTRACT

A method for managing application services is applied in a server. The server can communicate with at least one cloud service platform. Each cloud service platform includes a number of signal transmission APIs. The server includes a storage unit for storing at least one application service managing system and a virtual facilities operating system (VFOS). Each application service managing system has an API layer defining a plurality of request transmission APIs. The method includes: transmitting a request initiated by a user to one corresponding application service managing system by a call to the request transmission API included in the request, generating a control signal corresponding to the called request transmission API, determining a signal transmission API corresponding to the called request transmission API, and transmitting the control signal to the corresponding cloud service platform by a call to the determined signal transmission API.

### CROSS-REFERENCE TO RELATED APPLICATION

This application is related to co-pending U.S. patent application entitled, “SERVER AND METHOD FOR SHARING APPLICATION SERVICES”, filed ______ (Atty. Docket No. US54177). The application has the same assignee as the present application. The above-indentified application is incorporated herein by reference.

### FIELD

The present disclosure relates to cloud computing, and particularly to a server capable of managing application services, and a method for managing application services.

### BACKGROUND

Cloud computing can be defined as a computer network which includes a server or servers connected through a communication network. Many application service providers (ASPs) are planning to enter the cloud computing market. Any individual user who has permission to access the server can use the server to get access to a variety of application services provided by the ASPs, such as running applications, storing data, or performing any other computing task.

### BRIEF DESCRIPTION OF THE DRAWINGS

Implementations of the present technology will be described, by way of example only, with reference to the attached figures.

FIG. 1 is a block diagram of an embodiment of a server capable of managing application services.

FIG. 2 is a flowchart of an embodiment of a method for managing application services.

FIG. 3 is a sub-flowchart of a method for sharing extended application services included in the method of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth regarding control signals to provide a thorough understanding of the embodiments described herein. However, it will be understood by those of ordinary skill in the art that the embodiments described herein can be made to function without these specific details. In other instances, methods, procedures, and components have not been described in detail so as not to obscure the feature being described. Also, the description is not to be considered as limiting the scope of the embodiments described herein. The drawings are not necessarily to scale and the proportions of certain parts have been exaggerated to better illustrate details and features of the present disclosure.

A definition that applies throughout this disclosure follow.

The term “comprising,” means “including, but not necessarily limited to” and specifically indicates open-ended inclusion or membership in a combination, group, series, or the like.

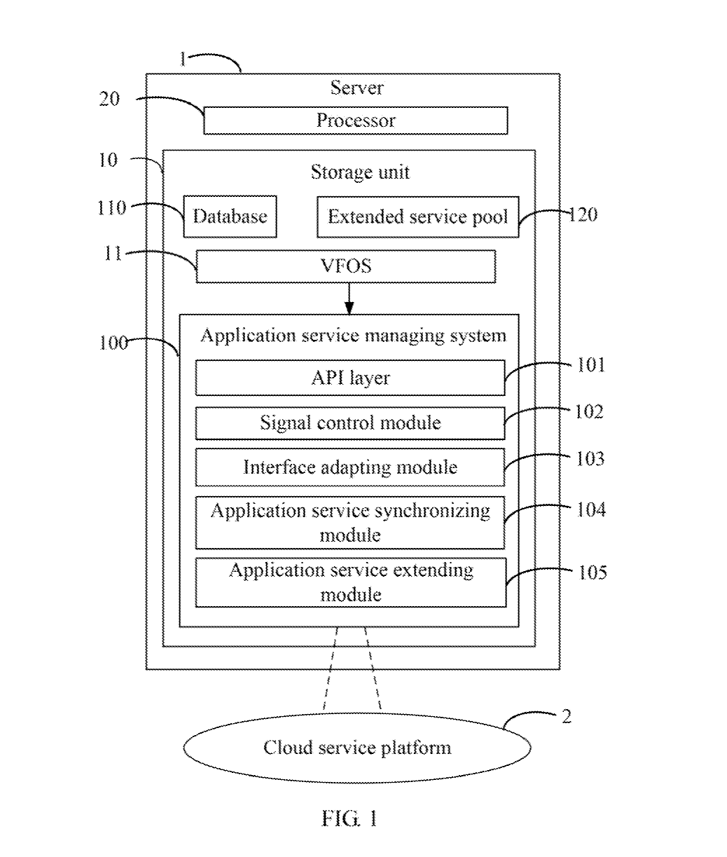

FIG. 1 is a block diagram of an embodiment of a server 1. The server 1 includes a storage unit 10 and a processor 20. The storage unit 10 stores a virtual facilities operating system (VFOS) 11 and at least one application service managing system 100. FIG. 1 shows only one system 100 for simplicity. However, a number of systems 100 can be varied according to need.

Each system 100 includes an application programming interface (API) layer 101 which defines a number of request transmission application programming interfaces (APIs, not shown). The VFOS 11 can communicate with each system 100 via a call to any request transmission API. Each system 100 can further connect to at least one cloud service platform 2, and access application services of each cloud service platform 2 via a call to any signal transmission API provided by the cloud service platform 2. The application service can be computation services, data access, or networking/routing and storage services.

Each system 100 further includes a variety of modules as a collection of software instructions executable by the processor 20 to provide the function of the system 100. In at least one embodiment, the system 100 includes a signal control module 102 and an interface adapting module 103.

The VFOS 11 provides a user interface for a user who wants to purchase an application service to initiate a request. The request includes information of the application service to be purchased and a request transmission API corresponding to the application service to be purchased. If the application service to be purchased is accessible by the server 1, the VFOS 11 transmits the request to the corresponding system 100 by a call to the request transmission API included in the request.

The signal control module 102 generates a control signal corresponding to the called request transmission API.

The interface adapting module 103 determines the signal transmission API corresponding to the called request transmission API, and transmits the control signal to the corresponding cloud service platform 2 by a call to the determined signal transmission API. Then, the cloud service platform 2 sets up or runs the application service to be purchased in response to the control signal.

In at least one embodiment, the storage unit 10 further stores a database 110. The database 110 includes a relationship between different request transmission APIs, control signals, and signal transmission APIs. Each request transmission API corresponds to one control signal and one signal transmission API. In this case, the signal control module 102 generates the corresponding control signal according to the relationship, and the interface adapting module 103 determines the corresponding signal transmission API according to the relationship. The relationship is updated each time the cloud service platform 2 sets up an application service.

In at least one embodiment, the system 100 further includes an application service synchronizing module 104. The application service synchronizing module 104 accesses the application services provided by the connected cloud service platform 2, and synchronizes the accessed application services to the VFOS 11, thereby allowing the user to purchase any application service via the VFOS 11.

It is notable that although different servers 1 may access different application services provided via different cloud service platforms 2, different services 1 can share application services. That is, via the VFOS 11 of one server 1, the user can purchase one application service (hereinafter, “extended application service”) not accessible by the server 1 but provided by another server.

In at least one embodiment, the system 100 further includes an application service extending module 105. The storage unit 10 further stores an extended service pool 120. The application service extending module 104 accesses the extended application service via a call to a signal transmission API corresponding to the extended application service (hereinafter, “extended service signal transmission API”), and adds the accessed extended application service to the extended service pool 120. Then, the application services synchronizing module 104 further synchronizes the extended application service in the extended service pool 120 to the VFOS 11. Such a method for sharing an extended application service is known in the subject matter of the co-pending application US54177.

In this case, the VFOS 11 further determines whether the request is for purchasing an extended application service. If so, the VFOS 11 transmits the request to the system 100 which has added the extended application service. The signal control module 102 generates a control signal corresponding to the request (hereinafter, “extended service control signal”). The interface adapting module 103 transmits the extended service control signal to the corresponding cloud service platform 2 via a call to the extended service signal transmission API. Then, the corresponding cloud service platform 2 sets up or runs the extended application service in response to the extended service control signal. In this case, the database 110 further includes the extended service control signal and the extended service signal transmission API corresponding to the extended application service.

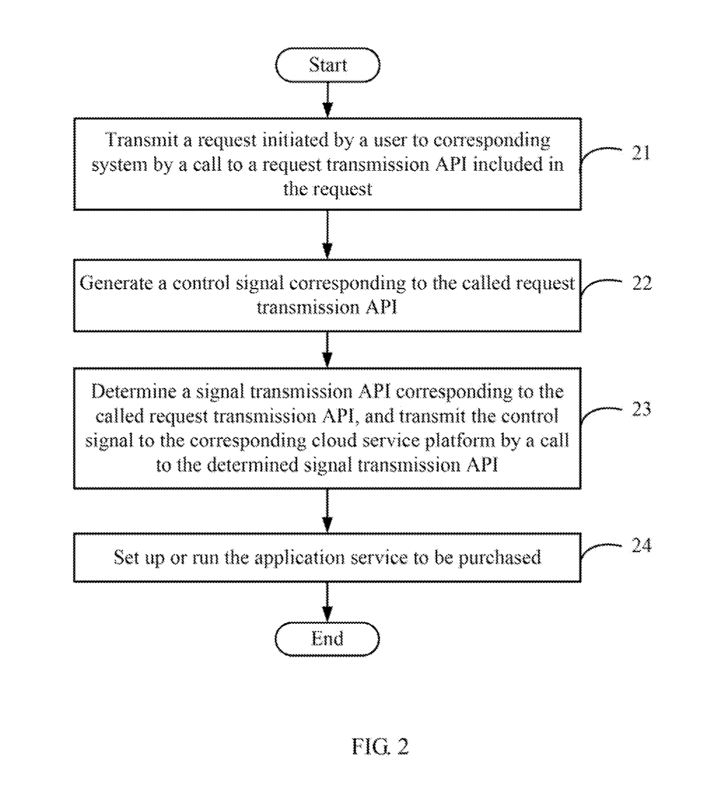

FIG. 2 is a flowchart of an embodiment of a method for manging application services applied in a server. The server includes a storage unit for storing a VFOS and at least one application service managing system. Each system connects to the VFOS and at least one cloud service platform.

In block 21, the VFOS transmits a request initiated by a user to the corresponding system via a call to a request transmission API included in the request.

In block 22, a signal control module of the system generates a control signal corresponding to the called request transmission API according to a relationship between different request transmission APIs and control signals.

In block 23, an interface adapting module of the system determines the signal transmission API corresponding to the called request transmission API according to a relationship between different request transmission APIs and signals transmission APIs, and transmits the control signal to the corresponding cloud service platform 2 by a call to the determined signal transmission API.

In block 24, the cloud service platform sets up or runs the application service to be purchased.

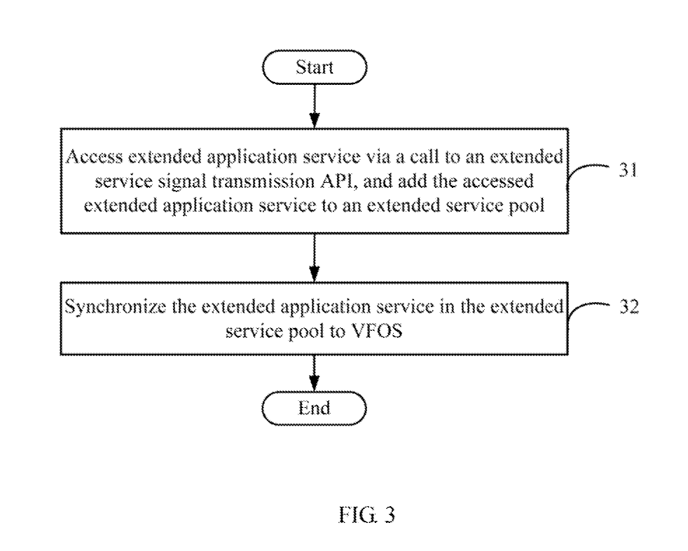

FIG. 3 is a sub-flowchart of a method for sharing extended application services included in the method of FIG. 2.

In block 31, an application service extending module accesses an extended application service via a call to an extended service signal transmission API, and adds the accessed extended application service to an extended service pool.

In block 32, an application services synchronizing module synchronizes the extended application service in the extended service pool to the VFOS.

The described embodiments and their advantages will be understood from the foregoing description. It will be apparent that various changes may be made thereto without departing from the scope of the disclosure or sacrificing all of its material advantages, the examples described merely being exemplary embodiments of the present disclosure. The described embodiments are not intended to limit the scope of the following claims.

What is claimed is:

1. A server capable of communicating with at least one cloud service platform, each cloud service platform having a plurality of signal transmission application programming interfaces (APIs), the server comprising:
a storage unit storing:
at least one application service managing system each having an API layer (101) defining a plurality of request transmission APIs; and
a virtual facilities operating system (VFOS) configured to transmit a request initiated by a user who wants to purchase an application service to one corresponding application service managing system by a call to a request transmission API included in the request; and
a processor to execute a plurality of modules of each application service managing system;
wherein the plurality of modules comprises:
a signal control module configured to generate a control signal corresponding to the called request transmission API; and
an interface adapting module configured to determine a signal transmission API corresponding to the called request transmission API, and transmit the control signal to the corresponding cloud service platform by a call to the determined signal transmission API, the control signal able to direct the corresponding cloud service platform to set up or run the application service to be purchased.

2. The server of claim 1, wherein the storage unit further stores a database, the database comprises a relationship between different request transmission APIs, control signals, and signal transmission APIs, each request transmission API corresponds to one control signal and one signal transmission API, the signal control module is configured to generate the corresponding control signal according to the relationship, the interface adapting module is configured to determine the corresponding signal transmission API according to the relationship.

3. The server of claim 2, wherein the relationship is updated each time the cloud service platform sets up an application service.

4. The server of claim 1, wherein each application service managing system further comprises an application service synchronizing module configured to access application services provided by the connected cloud service platform, and synchronize the accessed application services to the VFOS, thereby allowing the user to purchase any application service via the user interface provided by the VFOS.

5. The server of claim 4, wherein each application service managing system further comprises an application service extending module, the storage unit further stores an extended service pool, the application service extending module is configured to access an extended application service via a call to an extended service signal transmission API corresponding to the extended application service, and add the accessed extended application service to the extended service pool, the application services synchronizing module is further configured to synchronize the extended application service in the extended service pool to the VFOS.

6. The server of claim 5, wherein the VFOS transmits the request to the application service managing system which has added the extended application service when determining that the request includes information of an extended application service, the signal control module is configured to generate an extended service control signal corresponding to the request, the interface adapting module transmits the extended service control signal to the corresponding cloud service platform via a call to the extended service signal transmission API.

7. The server of claim 6, wherein the database further comprises the extended service control signal and the extended service signal transmission API corresponding to the extended application service.

8. A method for managing application services applied in a server, the server capable of communicating with at least one cloud service platform, each cloud service platform comprising a plurality of signal transmission APIs, the server comprising a storage unit for storing at least one application service managing system and a VFOS, each application service managing system having an API layer defining a plurality of request transmission APIs, the method comprising:
transmitting by the VFOS a request initiated by a user who wants to purchase an application service to one corresponding application service managing system by a call to a request transmission API included in the request;
generating by the application service managing system a control signal corresponding to the called request transmission API;
determining by the application service managing system a signal transmission API corresponding to the called request transmission API; and
transmitting by the application service managing system the control signal to the corresponding cloud service platform by a call to the determined signal transmission API, the control signal able to direct the corresponding cloud service platform to set up or run the application service to be purchased.

9. The method of claim 8, wherein the storage unit further stores a database, the database comprises a relationship between different request transmission APIs, control signals, and signal transmission APIs, each request transmission API corresponds to one control signal and one signal transmission API, the corresponding control signal is generated according to the relationship, the corresponding signal transmission API is determined according to the relationship.

10. The method of claim 8, further comprising:
accessing application services provided by the connected cloud service platform; and
synchronizing the accessed application services to the VFOS, thereby allowing the user to purchase any application service via the user interface provided by the VFOS.

11. The method of claim 10, further comprising:
accessing an extended application service via a call to an extended service signal transmission API corresponding to the extended application service;
adding the accessed extended application service to an extended service pool stored in the storage unit;
synchronizing the extended application service in the extended service pool to the VFOS.

12. The method of claim 11, further comprising:
transmitting by the VFOS a request to the application service managing system which has added the extended application service when determining that the request comprises information of an extended application service;
generating by the application service managing system an extended service control signal corresponding to the request; and
transmitting by the application service managing system the extended service control signal to the corresponding cloud service platform via a call to the extended service signal transmission API.
